(19) United States
(12) Patent Application Publication
(10) Pub. No.: US 2012/0155427 A1
(43) Pub. Date: Jun. 21, 2012

(54) Non-Optimized Handover By Locking The PDN Connection Configuration

(76) Inventor: Michael Francis Dolan, Bolingbrook, IL (US)

(21) Appl. No.: 12/971,331

(22) Filed: Dec. 17, 2010

(51) Int. Cl. H04W 36/00

(52) U.S. Cl. 370/331

(57) ABSTRACT

A call is established at a first network utilizing a first radio technology. The context for the call is locked at the first network. The call is handed over to a second network utilizing a second radio technology. The context is maintained at the first network. The call is handed over back to the first network and utilizes the context from the earlier portion of the call.

### FIELD OF THE INVENTION

The present invention relates generally to communication systems, and more particularly to handing over a call from a first communication system to a second communication system.

### BACKGROUND OF THE INVENTION

Mobile users utilizing mobile user equipment may have the need to hand off from a first radio technology to a different second radio technology. Optimized handovers involve tunneling signaling between systems to minimize the break in the bearer, or voice, path. Non-optimized handovers do not use such tunneling, and consequently the user equipment must perform signaling over the radio interface following handover prior to being able to send/receive data. This includes real-time data such as voice. For real-time services such as voice, non-optimized handover introduces up to as much as seven seconds of delay in reconnecting the voice path.

In particular, 3GPP2 X.S0057 revision 0 specifies that when a user equipment (UE) establishes a context for a packet data network (PDN) connection and then leaves the eHRPD system and moves to the LTE system, the PDN connection context must be deleted, thus requiring that it be reestablished upon return of the UE to the eHRPD system.

Therefore, a need exists for a method and system for handing over a call from a network utilizing a first radio technology to a network utilizing a second radio technology without incurring disruptive delays caused by the length of the handover, especially as it relates to the voice path of the ongoing call.

### BRIEF SUMMARY OF THE INVENTION

In an exemplary embodiment, user equipment (UE) attaches to the eHRPD system when the UE is first switched on. While attached to the eHRPD system, the UE preferably fully establishes a PPP session, performs authentication, and creates “locked” PDN connections for services that must incur a minimal break or gap during handover, e.g., lock the PDN connection for the PDN that will be used for voice services.

Creating “locked” PDN connections in the eHRPD is preferably accomplished using 3GPP2 X.S0057 VSNCP signaling. In accordance with an exemplary embodiment, the UE includes a new VSNCP “configuration option” that indicates to the HRPD Serving Gateway (HSGW) that it wants to lock the PDN connection as a component of “partial context”. The HSGW if it supports this capability, will include the same configuration option on the VSNCP signaling it sends to the UE, thus providing a negotiation mechanism between the UE and the HSGW. If both the UE and the HSGW include this new configuration option with the “locked” value setting on appropriate VSNCP signaling, each guarantees the other that no changes will be made to the configuration for that PDN connection, and that it will be kept as a component of “partial context” as specified in 3GPP2 X.S0057. The UE indicates to the HSGW when the PDN connection is established at first that it guarantees that this PDN connection will remain constant, even though the UE may move to another technology, e.g., LTE, and then return.

The interruption in the voice path for LTE to eHRPD non-optimized handovers is reduced significantly, making non-optimized handover more acceptable in the deployment of voice over LTE and eHRPD.

### BRIEF DESCRIPTION OF THE SEVERAL VIEWS OF THE DRAWINGS

FIG. 1 depicts a wireless network in accordance with an exemplary embodiment of the present invention.

FIG. 2 depicts a call flow diagram for UE-requested PDN connectivity procedure for eHRPD in accordance with an exemplary embodiment of the present invention.

### DETAILED DESCRIPTION OF THE INVENTION

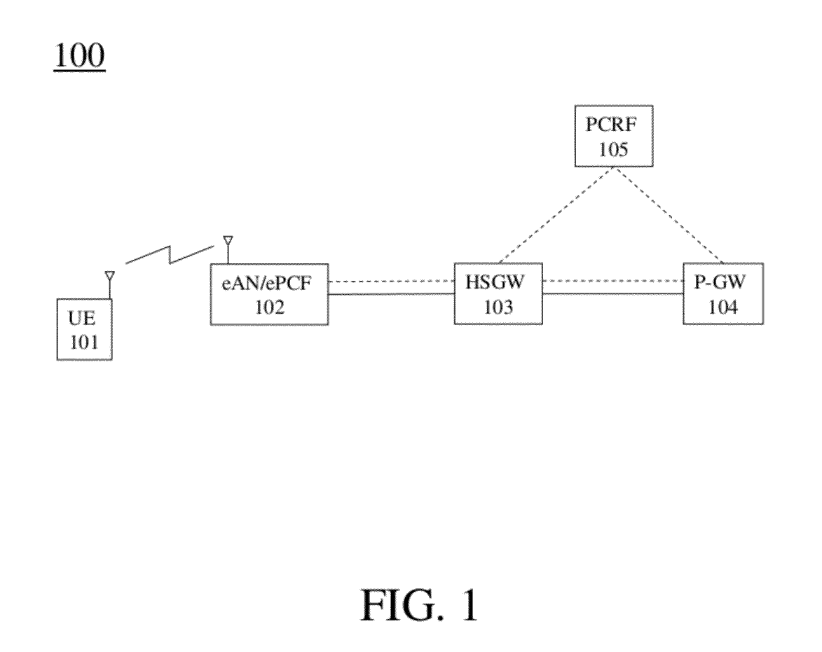

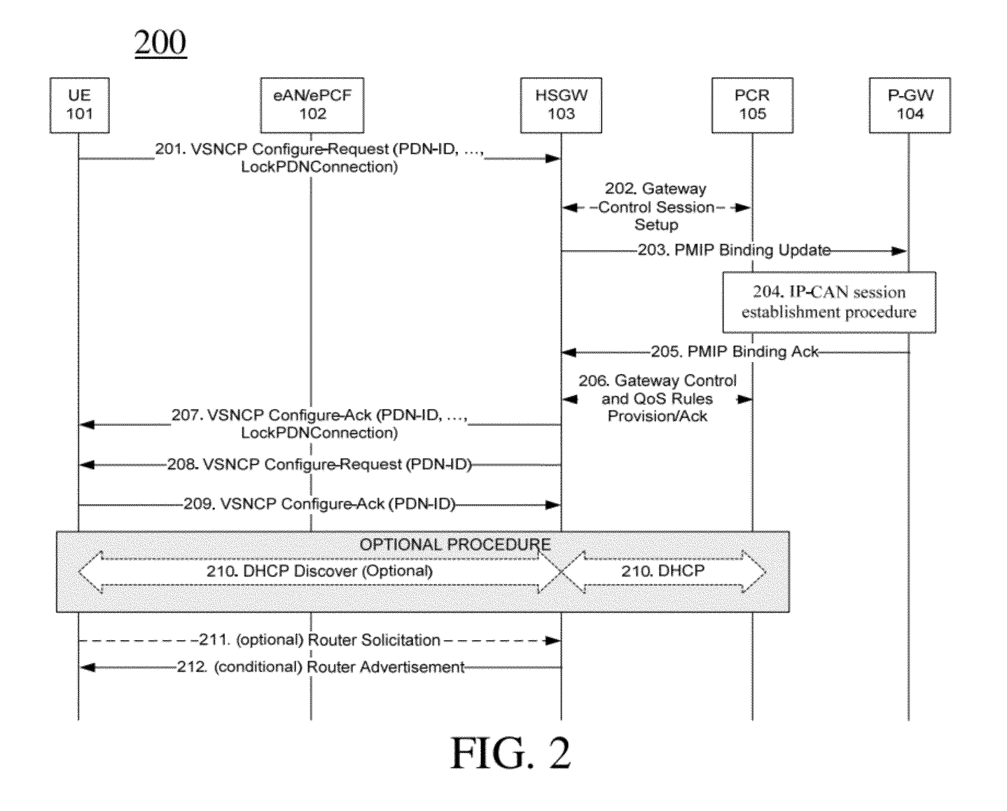

An exemplary embodiment of the present invention can be better understood with reference to FIGS. 1 and 2. FIG. 1 depicts a wireless network 100 in accordance with an exemplary embodiment of the present invention. In accordance with an exemplary embodiment, wireless network 100 is an LTE E2E wireless network. Wireless network 100 comprises eAN/ePCF 102, HSGW 103, P-GW 104, and PCRF 105. Wireless network 100 communicates with UE 101.

UE 101 is a mobile device that supports at least the LTE and eHRPD radio technologies.

eAN/ePCF 102 is a network component that embodies the radio access network technology aspects of eHRPD as defined by 3GPP2, and that supports IP packet transport from the UE to the HSGW.

HSGW 103 is the HRPD Serving Gateway that supports packet connectivity for the UE between the eAN/ePCF and the P-GW.

P-GW 104 is the Packet Data Network Gateway that supports connectivity for the UE, via the eAN/ePCF and HSGW, to one or more packet data networks.

PCRF 105 is the Packet Control and Routing Function that provides the policy rules to control the P-GW and HSGW.

FIG. 2 depicts a call flow diagram 200 for UE-requested PDN connectivity procedure for eHRPD in accordance with an exemplary embodiment of the present invention. This exemplary embodiment allows a UE to request connectivity to a new PDN. The default bearer for the new PDN preferably reuses the best effort service connection. The new PDN is preferably assigned a new and unique PDN-ID by the UE. In this exemplary embodiment, the UE is assumed to be in active mode via the eHRPD radio. In an alternate exemplary embodiment, the signaling is tunneled to the eHRPD eAN/ePCF from another technology, such as LTE. Proxy Mobile IP is preferably used on the PMIP-based S2a interface.

When UE 101 wants to establish connectivity to a PDN and lock that PDN connection as a component of partial context, UE 101 sends a VSNCP Configure-Request message 201 to HSGW 103. VSNCP Configure-Request message 201 is preferably sent using the PPP protocol. VSNCP Configure-Request message 201 preferably includes APN, PDN Address, PDN Type, Protocol Configuration Options (PCO), Attach Type, Address Allocation Cause, IPv4 Default Router Address, and LockPDNConnection fields, though it is possible that one or more of these fields may be omitted or other fields added in alignment with the protocol specified in 3GPP2 X.S0057.

The Protocol Configuration Options preferably include an Address Allocation Preference that indicates whether UE 101 wants to perform the IPv4 address allocation during the execution of the procedure. The PDN Type field preferably indicates that UE 101 is capable of supporting IPv4 and IPv6. IPv4 Default Router Address field is preferably set to “empty”. The Attach Type field is preferably set to “Initial Attach”. The LockPDNConnection field is preferably set to “yes”.

HSGW 103 verifies that the APN provided by UE 101 in VSNCP Configure-Request message 201 is allowed. In an exemplary embodiment, this can be provided to users as a subscription. If UE 101 supports Network Requested Bearer Control, then UE 101 includes the ‘MS Support of Network Requested Bearer Control indicator’ parameter in the Protocol Configuration Options.

In accordance with an exemplary embodiment, HSGW 103 notes the configuration options and agrees to support them, including particularly the LockPDNConnection option. HSGW 103 preferably triggers the procedures for UE-requested PDN connectivity, which establishes the bindings at new P-GW 104 and updates PCRF 105 with the indication of the new connection. In this exemplary embodiment, these steps occur using Gateway Control Session Setup message 202, PMIP Binding Update message 203, IP-CAN Session Establishment procedure 204, PMIP Binding Ack message 205, and Gateway Control and QoS Rules Provision/Ack message 206.

After HSGW 103 receives the indication of the completion of PMIPv6 procedures from P-GW 104, HSGW 103 sends VSNCP Configure-Ack message 207 to UE 101. VSNCP Configure-Ack message 207 is preferably sent using the PPP protocol. VSNCP Configure-Ack message 207 preferably includes APN, PDN Address, PCO, PDN-ID, Attach Type, Address Allocation Cause, IPv4 Default Router Address, and LockPDNConnection fields. The LockPDNConnection field is preferably set to “yes”.

The Protocol Configuration Options parameter indicates the Selected Bearer Control Mode when UE 101 includes the MS Support of Network Requested Bearer Control indicator (BCM) parameter in VSNCP Configure-Request message 201.

HSGW 103 sends VSNCP Configure-Request message 208 to UE 101, preferably utilizing the PPP protocol. VSNCP Configure-Request message 208 preferably includes the PDN-ID configuration option. VSNCP Configure-Request message 208 preferably includes the APN-AMBR, if the APN-AMBR was received from the HSS/AAA.

UE 101 responds with VSNCP Configure-Ack message 209, which preferably includes the PDN-ID configuration option. If VSNCP Configure-Request message 208 included the APN-AMBR, VSNCP Configure-Ack message 209 includes APN-AMBR if UE 101 supports APN-AMBR.

In accordance with an exemplary embodiment, IPv4 address allocation occurs at this point when the IPv4 address allocation is deferred. The IPv4 address allocation preferably occurs via DHCPDiscover procedure 210.

In accordance with a further exemplary embodiment, IPv6 address allocation occurs at this point via Router Solicitation message 211 and Router Advertisement message 212.

An exemplary embodiment of the present invention thereby provides a method of handing over a call from a network utilizing a first radio technology to a network utilizing a second radio technology without incurring disruptive delays caused by the length of the handover, especially as it relates to the voice path of the ongoing call.

Through the use of this “lock PDN connection” mechanism, the UE can establish the context for voice calls, including the PDN connection, all packet filters, etc., and know that these will remain intact in the HSGW even during the time that the UE may be attached to the LTE radio access network. Thus, the locked PDN connections are considered as components of “partial context”.

By having a guarantee that specific PDN connections will be maintained as part of partial context, the UE does not have to perform the signaling with the HSGW to re-establish those PDN connections when it returns to eHRPD from LTE.

While this invention has been described in terms of certain examples thereof, it is not intended that it be limited to the above description, but rather only to the extent set forth in the claims that follow.

I claim:

1. A method for handing over user equipment from a first communication system to a second communication system, the method comprising:
attaching user equipment to a second communication system;
establishing a PDN session between the user equipment and the second communication system;
handing over the user equipment to a first communication system;
handing over the user equipment from the first communication system to the second communication system; and
utilizing the PDN session by the user equipment.

2. A method for handing over user equipment in accordance with claim 1, the method further comprising the step of establishing a PPP session at the second communication system prior to handing over to the first communication system.

3. A method for handing over user equipment in accordance with claim 1, the method further comprising the step of performing authentication of the user equipment at the second communication system prior to handing over to the first communication system.

4. A method for handing over user equipment in accordance with claim 1, the method further comprising the step of locking the PDN connection prior to handing over to the first communication system.

5. A method for handing over user equipment in accordance with claim 1, wherein the step of utilizing the PDN session by the user equipment comprises utilizing the PDN session for voice services.

6. A method for handing over user equipment in accordance with claim 1, wherein the step of establishing a PDN session between the user equipment and the second communication system comprises establishing a PDN session between the user equipment and the second communication system using 3GPP2 signaling.

7. A method for handing over user equipment in accordance with claim 1, wherein the step of establishing a PDN session between the user equipment and the second communication system using 3GPP2 signaling comprises establishing a PDN session between the user equipment and the second communication system using 3GPP2 X.S0057 VSNCP signaling.

8. A method for handing over user equipment in accordance with claim 1, the method further comprising the step of tunneling voice signaling from the first communication system to the second communication system.

9. A method for handing over user equipment in accordance with claim 8, wherein the step of tunneling voice signaling from the first communication system to the second communication system comprises utilizing Proxy Mobile IP.

10. A method for handing over user equipment in accordance with claim 9, wherein the step of utilizing Proxy Mobile IP comprises utilizing a DHCP procedure.

11. A method for handing over user equipment in accordance with claim 1, wherein the step of establishing a PDN session between the user equipment and the second communication system is allowed only if the user equipment has subscribed to a handover service.

12. A method of handing over a call from a first network utilizing a first radio technology to a second network utilizing a second radio technology, the method comprising:
establishing a call at a first network utilizing a first radio technology;
locking the context for the call at the first network;
handing over the call to a second network utilizing a second radio technology while maintaining the context at the first network; and
handing over the call from the second network to the first network while using the context.

13. A method of handing over a call in accordance with claim 12, wherein the step of locking the context comprises locking the PDN connection.

14. A method of handing over a call in accordance with claim 12, wherein the step of locking the context comprises locking all packet filters relating to the call.

15. A method of handing over a call in accordance with claim 12, wherein the step of handing over the call from the second network to the first network comprises handing over the call without having to re-establish locked PDN connections at the first network.

16. A method of handing over a call in accordance with claim 12, wherein the step of locking the context for the call at the first network is allowed only if a user equipment has subscribed to a handover service.
